(19) United States
(12) Patent Application Publication
(10) Pub. No.: US 2020/0046186 A1
(43) Pub. Date: Feb. 13, 2020

(54) CLEANING APPARATUS FOR REMOVING PESTS AND METHODS OF USING SAME

(71) Applicant: Terramera, Inc., Vancouve (CA)

(72) Inventors: Nathan WOODBURY, Burnaby (CA); Robert James Etsu TAKEUCHI, Vancouver (CA); Alyssa WONGKEE, Vancouver (CA)

(21) Appl. No.: 16/497,292

(22) PCT Filed: Mar. 26, 2018
(86) PCT No.: PCT/CA2018/050362

§ 371 Date: Sep. 24, 2019

Related U.S. Application Data
(60) Provisional application No. 62/477,923, filed on Mar. 28, 2017.

(51) Int. Cl. A47L 9/10; A01M 3/00; B01D 46/10; B01D 46/00

(52) U.S. Cl. CPC A47L 9/104; A01M 3/005; B01D 2279/55; B01D 46/0027; B01D 46/10

(57) ABSTRACT

A cleaning apparatus engageable with a vacuum source is provided. The vacuum source can be used to draw fluid through an interior space of a housing of the cleaning apparatus through an inlet tube so that debris entrained in the fluid collects in a debris collection zone upstream of a downstream opening in the inlet tube. Methods of using the cleaning apparatus are provided.

### REFERENCE TO RELATED APPLICATIONS

This application claims priority to and the benefit of U.S. provisional patent application No. 62/477,923 filed 28 Mar. 2017, which is incorporated by reference herein in its entirety for all purposes.

### TECHNICAL FIELD

Some embodiments of the present invention relate to cleaning apparatus for removing pests. Some embodiments of the present invention relate to apparatus enabling the removal of pests using a vacuum. Some embodiments of the present invention relate to a cleaning apparatus that is engageable with a vacuum to enable the removal of pests using the vacuum. Some embodiments of the present invention relate to methods of using such apparatus.

### BACKGROUND

The removal of pests from a given location using a vacuum poses particular challenges. Although the pests may be sucked into the canister or bag of the vacuum, the pests or their eggs frequently are not killed as part of this process. Accordingly, the pests may crawl out of the canister or bag of the vacuum and re-infest a space after cleaning. If the vacuum is moved to a new location, the pests may crawl out of the canister or bag of the vacuum and infest the new location.

Removal of different pests can entail different procedures. For example, a typical procedure to remove bed bugs from a given location involves the use of a liquid pesticide, for example that is applied in a spray form. However, because bed bugs, including juvenile bed bugs, may be able to hide under the cast skins of bed bugs or other debris, liquid pesticide may not achieve full effectiveness. A standard procedure is therefore to vacuum a surface before applying liquid pesticide, to remove cast skins and other debris that may shelter bed bugs from the applied pesticide. However, as previously noted, vacuuming up pests such as bed bugs or their eggs using a vacuum may facilitate reinfestation.

Accordingly, it is desirable to prevent the bed bugs and their eggs from being sucked into the canister or bag of the vacuum. For this purpose, some people have applied a nylon stocking over the free end of a vacuum tube, to prevent bed bugs and/or their eggs from being sucked into the vacuum. This practice has risks, however, as sometimes the nylon stocking can be sucked into the vacuum, permitting the bed bugs and/or their eggs to enter the canister or bag of the vacuum.

In the case where the pests are dust mites, the mites and the feces, eggs and cast skins of the dust mites are themselves allergens ranging in size from 1-300 microns in diameter (Custovic et al. 1999, Calderón et al. 2015). The mere killing of dust mites reduces their rate of population growth but does not remove the allergens associated with them. It is desirable to remove these allergens using a vacuum cleaner. However, due to their small size, these allergen particles can exit many household vacuum cleaners through the filter of the vacuum cleaner, thereby releasing the allergens back into the surrounding environment. Accordingly, while it is desirable to vacuum up dust mites to facilitate their removal, including vacuuming up allergens such as dust mite feces and cast skins as part of the process of removing such pests and allergens and after applying a liquid pesticide, it may be necessary to use a high-efficiency particulate resistance (HEPA) filter or similar fine filter that captures the small allergen particles having a size of about 1 micron or larger.

Potentially venomous pests such as spiders, fast moving pests such as cockroaches and silverfish, and flying pests such as fruit flies, house flies, bottle flies, pantry moths and mosquitos are also undesirable and can be captured while running or in flight using a household vacuum cleaner. However, the user of the vacuum cleaner may fear those pests surviving within the vacuum cleaner or escaping the vacuum cleaner once it is opened. A filter that traps these pests before they enter the vacuum may be desirable in such cases.

It is also desirable to provide new means to remove and isolate pests from ornamental or vegetable plants in gardens or in lawns. Examples of such plant pests are aphids, thrips, whiteflies, scales, psyllids, mites, beetles, stink bugs and caterpillars.

There is a general desire for improved apparatus and methods for removing pests from a given location. There is also a general desire for improved apparatus and methods for preventing debris from entering the bag or canister of a vacuum cleaner. For example, people may wish to vacuum up debris such as drywall dust, pet hair, pet dander, or the like, without having such debris enter a bag or canister of their vacuum.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a cleaning apparatus for attachment to a vacuum source. The cleaning apparatus has a housing defining an interior space and being engageable with the vacuum source to draw fluid through the interior space in a downstream direction. The fluid comprises both air and debris. A filter is provided in a downstream portion of the housing and engaged with the housing so that the air exiting the interior space must pass through the filter, and an inlet tube is engaged with the housing and spaced apart from the filter in the upstream direction.

In some aspects, the inlet tube provides a fluid flow pathway to direct fluid entering the interior space. In some aspects, the inlet tube produces a Venturi effect in fluid flowing therethrough. In some aspects, fluid flowing through the inlet tube is initially directed in the upstream direction towards a debris collection zone of the interior space to deposit the debris in the debris collection zone. The debris collection zone is positioned upstream of an inlet aperture of the inlet tube.

In some aspects, the inlet tube and the filter are spaced apart by a sufficient distance so that the debris entering the interior space through the inlet tube does not generally impact on the filter. In some aspects, the filter has a generally conical shape with an apex and a base, and the apex of the filter is oriented in the upstream direction within the housing. In some aspects, the inlet aperture of the inlet tube is provided with a one-way valve, to allow fluid to flow only into the housing.

In some aspects, the housing is provided with features that facilitate the capture and release of live organisms. In some aspects, such features include a sealable window, a vacuum bleed to allow for selective control of the vacuum pressure within the housing, and/or a releasable engagement between components of the cleaning apparatus that allows the organism to be released from the interior of the housing.

In some aspects, one or more covers are provided to seal the cleaning apparatus to prevent the escape of any pests contained therein. In some aspects, the cleaning apparatus can be treated, for example using vapors of a pesticidal composition or microwave radiation, to kill any pests contained therein.

In some aspects, one or more adapters are provided to allow the cleaning apparatus to be connected in fluid communication with a plurality of different vacuum sources having connection hoses of differing diameters. In some aspects, the cleaning apparatus is provided as part of a kit with one or more such adapters.

In some aspects, methods of using the cleaning apparatus are provided. In one aspect, a negative pressure is provided at a downstream end of a housing of the cleaning apparatus using a vacuum source. Using the pressure differential created by the vacuum source, fluid is drawn through a fluid pathway defined by an inlet tube provided at an upstream end of the housing into an interior space of the housing, and air exiting the housing is drawn through a filter positioned downstream of the inlet tube. In some aspects, a Venturi effect is produced as the fluid is drawn through the fluid pathway defined by the inlet tube. In some aspects, debris present in the fluid that is drawn into the cleaning apparatus accumulates in a debris accumulation zone in an upstream portion of the interior space.

In some aspects, any pests trapped in the cleaning apparatus are killed after use of the cleaning apparatus. In some aspects, the pests are killed after use by microwaving the cleaning apparatus or by exposing pests trapped inside the cleaning apparatus to pesticidal vapors by enclosing or sealing the cleaning apparatus and introducing a pesticidal composition that releases vapors into the enclosure or cleaning apparatus.

In some aspects, the cleaning apparatus is used to trap undesired materials such as drywall dust, pet hair or pet dander before such undesired materials enter a vacuum source to which the cleaning apparatus is connected.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 shows a front view of a cleaning apparatus according to an example embodiment.

FIG. 2 shows a cross-sectional view of the embodiment of FIG. 1, taken along line B-B.

FIG. 3A shows a top view of the embodiment of FIG. 1.

FIG. 3B shows a top view of an example embodiment of a suction attachment.

FIG. 3C shows a front view of the suction attachment of FIG. 3B.

FIG. 3D shows a side view of an inlet to the central chamber according to one example embodiment.

FIG. 4 shows a front exploded view of the embodiment of FIG. 1.

FIG. 5 shows a perspective exploded view of the embodiment of FIG. 1.

FIG. 6A shows a cross-sectional view of an example embodiment of a cleaning apparatus.

FIG. 6B shows a partial enlarged view showing the engagement of an airflow cone with the other components of the cleaning apparatus of FIG. 6A.

FIG. 7A shows an example embodiment of an airflow cone having a one-way valve at its downstream end.

FIG. 7B shows a second example embodiment of an airflow cone having a one-way valve at its downstream end.

FIG. 7C shows a third example embodiment of an airflow cone having a one-way valve at its downstream end.

FIG. 7D shows a fourth example embodiment of an airflow cone having a one-way valve at its downstream end.

FIG. 7E shows a fifth example embodiment of an airflow cone having a one-way valve at its downstream end.

FIG. 8A shows a cross-sectional view of the embodiment of FIG. 1, taken along line B-B.

FIG. 8B shows a photograph of an example embodiment of a prototype cleaning apparatus that the inventors have constructed and tested, oriented at 150° to the vertical (i.e. with the vacuum attachment end pointing upwards), with an applied suction force from a vacuum source to cause debris to accumulate in a debris collection area.

FIG. 8C shows a photograph of the example embodiment of FIG. 8 oriented at 220° to the vertical (i.e. with the vacuum attachment pointing downwards), with no applied suction force from a vacuum source.

FIGS. 9A, 9B and 9C show an example embodiment of a cover for sealing the housing when the cleaning apparatus is not in use. FIG. 9A is an exploded view showing the lid bearing an absorbent pad that can be impregnated with a pesticidal composition, the housing and a base, which can be inserted on the upstream end of the housing when the suction attachment has been removed. FIG. 9B is an enlarged view that shows the lid bearing the absorbent pad in greater detail. FIG. 9C shows the direction a user would pull to remove a frictionally engaged suction attachment from the housing.

FIG. 10A shows an example embodiment of a cleaning apparatus having a removable cover for covering the suction attachment and having a cover for the downstream end of the housing. FIG. 10B is an enlarged view of an example embodiment of the cover for the downstream end of the housing or a vacuum adapter that may be used therewith.

FIG. 11 shows an example embodiment in which a sealable bag is provided to cover the upstream end of the housing and/or the suction attachment after use of the cleaning apparatus.

FIGS. 12A and 12B show example embodiments of a cleaning apparatus in which the housing, airflow cone and filter are provided in the form of an exchangeable cartridge.

FIG. 13 shows schematically an example embodiment of a kit comprising a plurality of adapters with different diameters for coupling the cleaning apparatus to vacuum sources having connection hoses having a plurality of different diameters.

FIGS. 14A, 14B and 14C illustrate alternative example embodiments of nesting adapters.

FIGS. 15A and 15B show front and side views, respectively, of an alternative embodiment of a cleaning apparatus that is particularly suited to the removal of bed bugs from a particular area.

FIG. 16 shows schematically an example embodiment of a cleaning apparatus having features to allow the apparatus to be more easily used to collect a live organism from a first location and release the live organism in a second location.

FIG. 17 shows schematically an example embodiment of another cleaning apparatus having alternative features to allow the apparatus to be used to more easily collect a live organism from a first location and release the live organism in a second location.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

As used herein, “pests” means organisms that negatively affect a host or other organism—such as a plant or an animal such as a mammal—by colonizing, damaging, attacking, competing with them for nutrients, or infecting them, as well as undesired organisms that infest human structures, dwellings, living spaces or foodstuffs. Pests can include arthropods, including insects, arachnids and cockroaches, and includes sucking, biting and stinging pests such as bed bugs, kissing bugs, mites, including dust mites, ticks, ants, lice, fleas, chiggers, biting flies, mosquitoes, and wasps, as well as insects such as moths, mites and weevils. In some embodiments, the pests are bed bugs. In some embodiments, the pests are dust mites. In some embodiments, the pests are fleas, lice, cockroaches, spiders, ants, flying insects, or the like. In some embodiments, the pests are silverfish, fruit flies, house flies, bottle flies, aphids, thrips, whiteflies, scales, psyllids, stink bugs and caterpillars.

As used herein, “vacuum” means any apparatus capable of generating a pressure that is reduced relative to atmospheric pressure to yield a suction effect through a vacuum hose sufficient to suck up pests, cast skins, dust, debris, or the like. Typically, atmospheric pressure is approximately 760 mmHg, although those skilled in the art will recognize that factors such as elevation and prevailing weather conditions can cause atmospheric pressure to deviate slightly from this value.

As used herein, “debris” is used to refer to all materials other than air that may be sucked up by an applied vacuum pressure, including, for example, dust (including e.g. drywall dust), dirt, pests, pest eggs, cast skins from pests, and the like.

As used herein “fluid” is used to refer to all materials that may be sucked up by an applied vacuum pressure, including both air and debris. In some embodiments the fluid that is sucked up by the applied vacuum pressure includes air with debris entrained therein.

As used herein, high-efficiency particulate or HEPA filter means a filter that removes (from the air that passes through the filter) at least 99.97% of particles that have a size of 0.3 microns.

As used herein, “upstream” means a direction towards the suction inlet of a vacuum apparatus, and “downstream” means a direction towards the vacuum source of a vacuum apparatus. For example, with reference to a conventional vacuum, the vacuum attachment coupled to a vacuum hose operated by a user would be at the upstream end, while the bag or canister of the vacuum would be at the downstream end. Air flowing through the vacuum when the vacuum is operating in a suction mode travels from the upstream end to the downstream end of the vacuum apparatus.

As used herein, the terms “inner” or “inward” refer to a direction towards the axial centreline of the housing of the cleaning apparatus. As used herein, the terms “outer” or “outward” refer to a direction away from the axial centreline of the housing of the cleaning apparatus.

As used herein, the term “slippery pest control surface” refers to a surface that pests cannot climb, crawl or otherwise easily move along. For example, a pest tends to slide off a slippery surface. As used herein, the term “sticky pest control surface” refers to a surface that pests cannot climb, crawl or otherwise easily move along because the pest becomes adhered to the sticky surface. For example, flypaper would be an example of a sticky pest control surface.

The inventors have now developed a cleaning apparatus that can be used to collect debris, including pests and pest eggs, and prevent pests and/or pest eggs from entering the vacuum source, for example the canister or bag of a vacuum cleaner. In one example embodiment, the cleaning apparatus has a housing that can be engaged at its downstream end with a vacuum source (for example, the connection hose of a vacuum cleaner), and can optionally be engaged at its upstream end with a suction attachment (for example, a crevice tool, floor tool, upholstery tool or the like of a vacuum cleaner). When suction is applied by the vacuum source, air and debris enter the upstream end of the cleaning apparatus, travel through an inlet tube, such as an air flow cone, that directs the flow of air within a central chamber of the housing so that debris is directed to a debris collection zone in the upstream portion of the central chamber, upstream of an aperture of the airflow cone through which fluid enters the central chamber. A filter is positioned at the downstream end of the central chamber, to minimize the passage of any debris (including pests and pest eggs, and in some embodiments further including dust and other allergens such as cast skins) through to the vacuum source. In some embodiments, the filter is provided as a generally planar filter having a relatively flat surface. In some embodiments, the filter is provided with a conical shape, with its vertex oriented in the upstream direction, to minimize the accumulation of debris on the upstream surface of the filter.

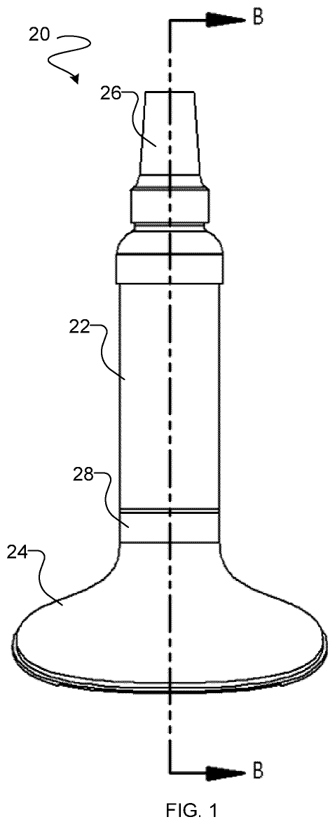

With reference to FIG. 1, an example embodiment of a cleaning apparatus 20 is illustrated. Cleaning apparatus 20 has a central housing 22, a suction attachment 24, and a vacuum attachment end 26. In some embodiments, vacuum attachment end 26 is also referred to as an adapter, since it is used to couple cleaning apparatus 20 to a vacuum source, for example via a connection hose of the vacuum source. In the illustrated embodiment, suction attachment 24 is coupled to an inlet 28 that is in fluid communication with central housing 22.

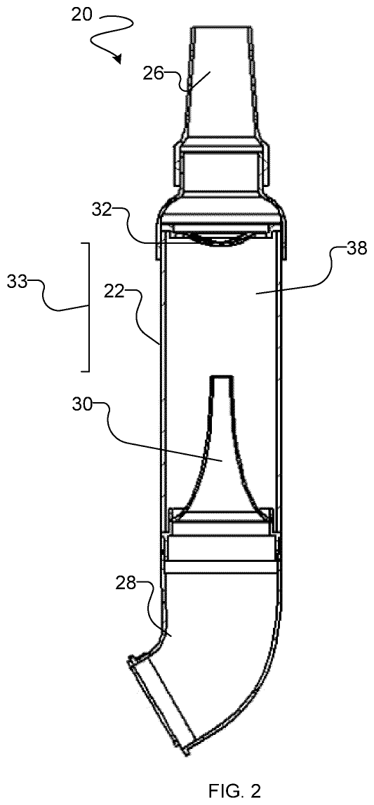

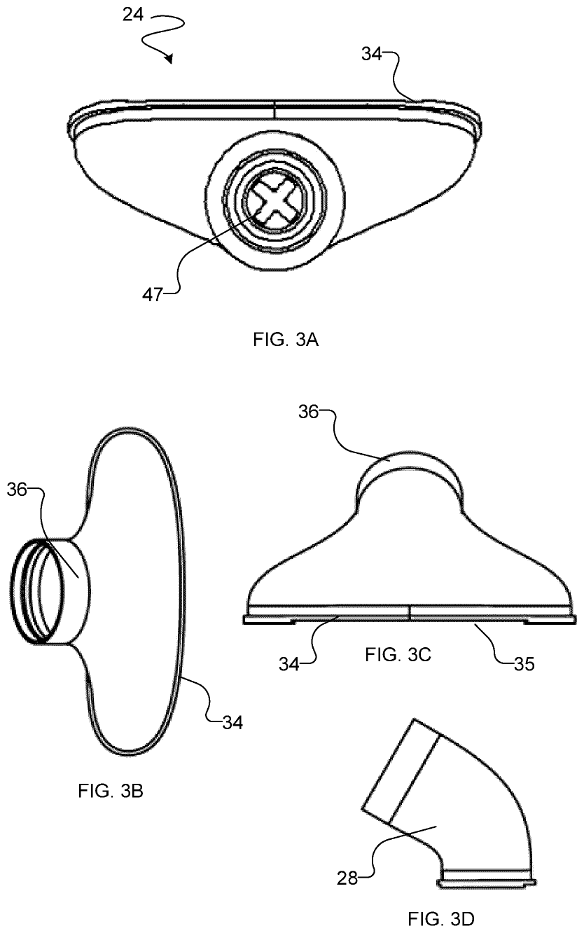

With reference to FIG. 2, it can be seen that in the illustrated embodiment, inlet 28 has a curved configuration. In some embodiments, providing an inlet 28 with a curved configuration assists in allowing a user to easily position the contact base 34 (FIGS. 3B and 3C) of suction attachment 24 parallel to the surface to be vacuumed. In alternative embodiments, inlet 28 could be straight, or could be omitted altogether so that suction attachment 24 would be coupled directly onto central housing 22. In some embodiments, suction attachment 24 is omitted altogether, and fluid, including debris, is vacuumed directly into central housing 22 without the use of any sort of vacuum suction attachment.

Cleaning apparatus 20 is provided with an airflow cone 30 at the upstream end of central housing 22. Airflow cone 30 is an example of an inlet tube that is used to provide a fluid flow pathway to direct fluid entering the interior space 38 of central housing 22. Cleaning apparatus 20 is also provided with a filter 32 at the downstream end of central housing 22. While airflow cone 30 and filter 32 are described as being positioned at the upstream and downstream ends, respectively, of central housing 22, it will be apparent to those skilled in the art that these elements need not be positioned specifically at such ends, and in some embodiments could occupy an intermediate position within central housing 22, so long as airflow cone 30 and filter 32 are spaced apart by a sufficient distance to perform their respective functions as described below. In FIG. 2, the space between airflow cone 30 and filter 32 is illustrated as 33, and is measured between the downstream tip of airflow cone 30 and the upstream surface of filter 32.

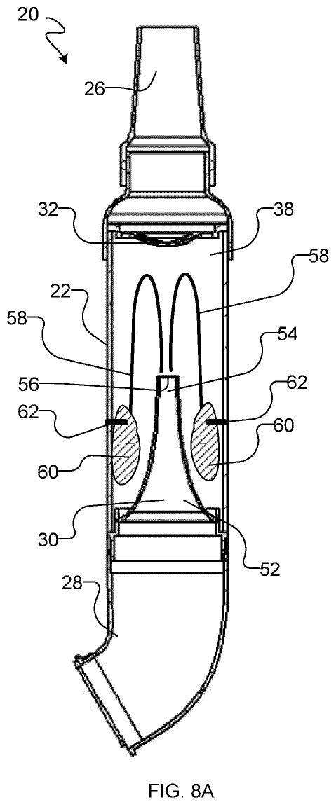

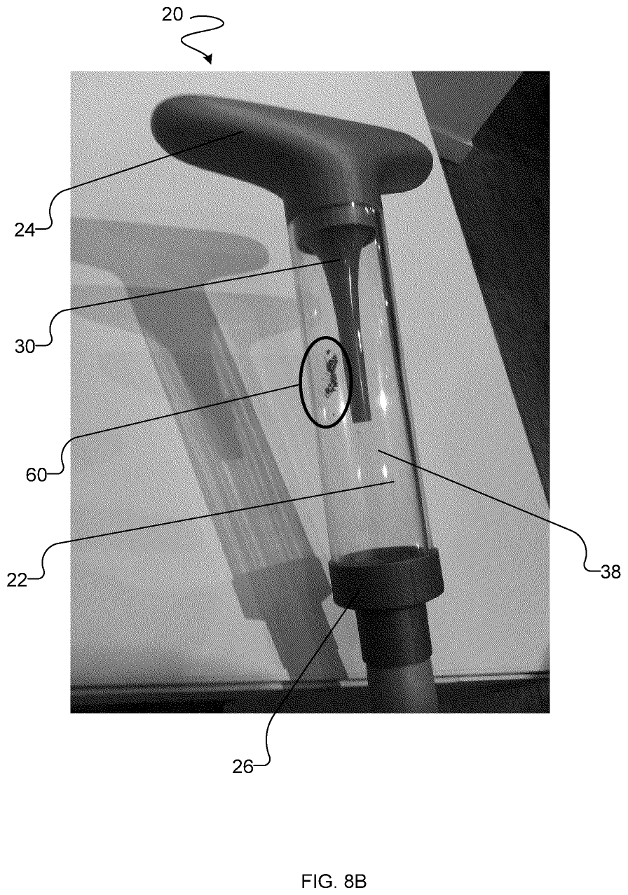

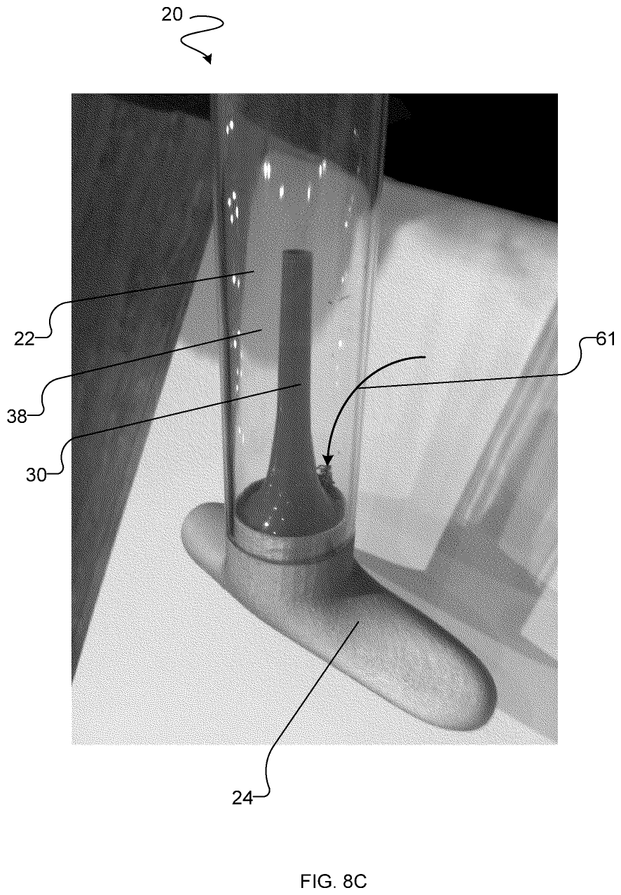

In some embodiments, central housing 22 is made from a transparent material, for example, nitrocellulose, polypropylene, high-density polyethylene, low-density polyethylene, polyvinyl chloride, acrylonitrile butadiene styrene, polymethyl methacrylate, cellulose acetate butyrate, polycarbonate, glycol modified polyethylene terephthalate, styrene acrylonitrile, nylon, polylactic acid, polyhydroxyalkanoate, polytetrafluoroethylene, polystyrene, or the like. In such embodiments, a user may see the interior space 38 of central housing 22, to visually inspect the flow and accumulation of debris therein, and/or to visually inspect filter 32 for clogging or accumulation of debris. In some such embodiments, central housing 22 is provided with markings 62 (FIG. 8A), so that a user can visually evaluate the degree to which debris has accumulated within the interior space 38 of central housing 22.

In some embodiments, airflow cone 30 is made from a slippery pest control material that pests cannot climb, crawl or otherwise easily move along. For example, in some embodiments, airflow cone 30 is made from polypropylene, high-density polyethylene, low-density polyethylene, polyvinyl chloride, polymethyl methacrylate, cellulose acetate butyrate, polycarbonate, glycol modified polyethylene terephthalate, styrene acrylonitrile, acrylonitrile butadiene styrene, nylon, polylactic acid, polyhydroxyalkanoate, polytetrafluoroethylene, polystyrene, thermoplastic olefin, or the like. In some embodiments, the outer surface of airflow cone 30 is made from or coated with a relatively slippery pest control material that pests cannot climb, crawl, or otherwise easily move along, for example, the materials listed above or a coating of Teflon® or other similar material. In alternative embodiments, the outer surface of airflow cone 30 is provided with a very sticky pest control material, for example a sticky adhesive such as that used in Tanglefoot® insect barriers and traps or flypaper, that pests cannot climb, crawl or otherwise easily move along. In such embodiments, the fact that pests cannot climb, crawl, or otherwise easily move along airflow cone 30 helps to trap pests inside central housing 22. Those skilled in the art will recognize that in embodiments where airflow cone 30 is provided with a sticky pest control material, the ability of airflow cone 30 to restrict the movement of pests thereon will start to be diminished as dust and/or debris adheres to the sticky pest control material.

The configuration of airflow cone 30 itself can help to trap pests inside central housing 22. For example, in embodiments in which the pests to be collected are flying insects, the fact that airflow cone 30 has a relatively small aperture 56 (FIG. 5) to allow the pests to exit and is relatively long along its axial centreline is largely sufficient to trap pests inside central housing 22, without the need for any specific feature to be provided on the outside surface of airflow cone 30, as might be provided in embodiments in which the pests to be collected are not flying insects.

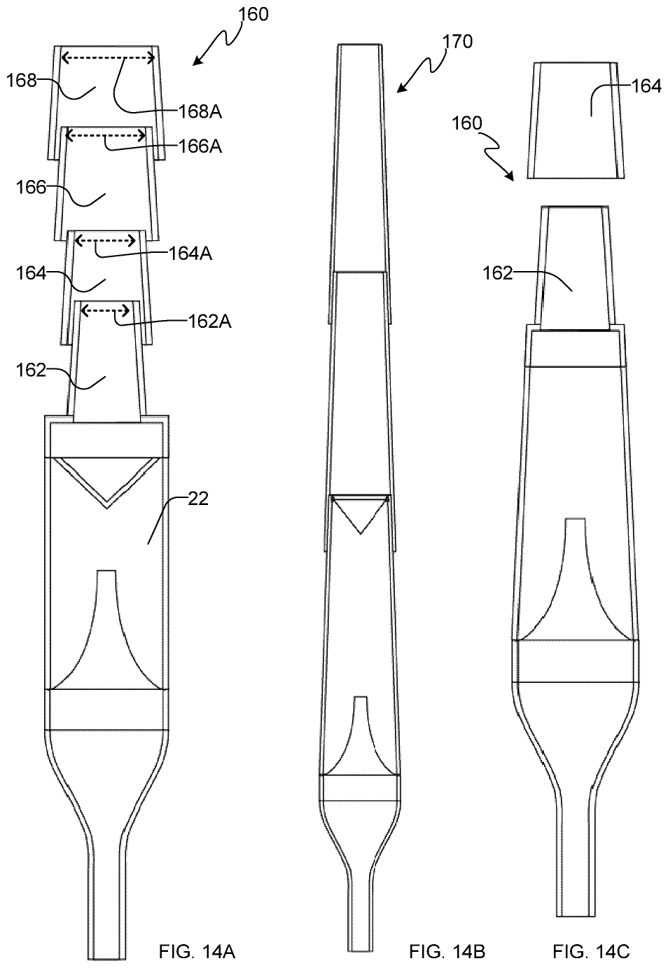

Vacuum attachment end 26 is provided with any configuration or adapter suitable to be coupled to the suction inlet of a vacuum, for example via the connection hose typically provided on a vacuum. In some embodiments, cleaning apparatus 20 is provided with one or more adapters (examples embodiments of which are shown in FIG. 13 and FIGS. 14A-C), to allow cleaning apparatus 20 to be coupled to two or more different vacuums having suction inlets of varying diameters. In some embodiments, cleaning apparatus 20 is sold as part of a kit, and the kit includes one or more adapters, or a plurality of adapters (e.g. as shown in FIG. 13 and FIGS. 14A-C), e.g. two, three, four, five, six, seven, eight, nine or ten different adapters, enabling cleaning apparatus 20 to be coupled to a plurality of different vacuums having suction inlets of differing diameters. An example of the different range of diameters of vacuum suction inlets found on typical vacuum units in common use includes 25 mm to 45 mm and more, including any value therebetween, e.g. 30, 35 or 40 mm.

Suction attachment 24 can comprise any suitable vacuum suction attachment, or may be omitted altogether in some embodiments. Non-limiting examples of vacuum suction attachments that can be used to provide suction attachment 24 include floor brushes, rug brushes, crevice tools, upholstery attachments, dusting brushes, pet brushes, extension wands, and the like. A person skilled in the art can select an appropriate suction attachment 24 depending on the desired application.

Suction attachment 24 has a contact base 34 (FIGS. 3A, 3B, 3C) for contacting the surface to be cleaned, an intake 35 through which fluid can flow, and an outlet 36 that is engageable with inlet 28 (FIG. 3D) to place suction attachment 24 in fluid communication with the interior space 38 of central housing 22. The shape and configuration of suction attachment 24 and contact base 34 can be varied in different embodiments, depending on the required application or use of cleaning apparatus 20.

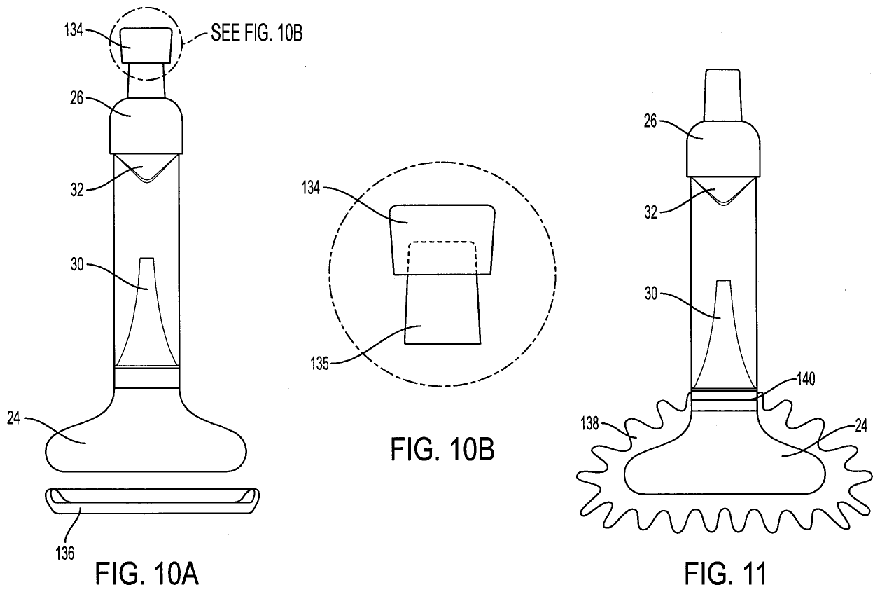

In some embodiments, a cover is provided (an example embodiments of which is shown in FIG. 10A as 136), that is engageable with contact base 34 to seal the upstream end of suction attachment 24. Such a cover may, for example, help to prevent pests from crawling out of the canister or bag of the vacuum to which cleaning apparatus 20 is attached, or may prevent pests or their eggs that might adhere to contact base 34 from escaping away from suction attachment 24.

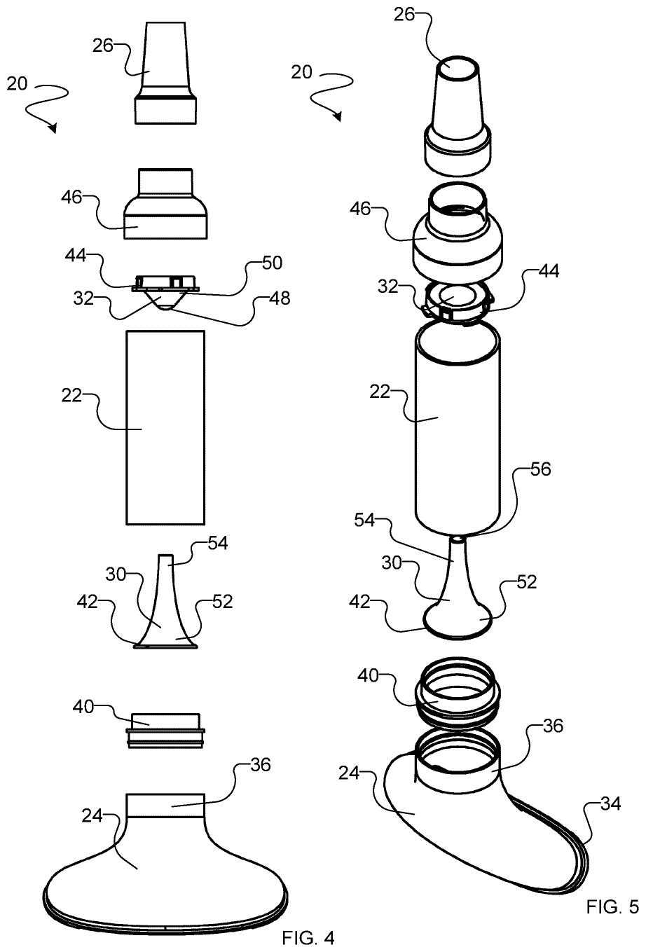

The engagement of the various components of the illustrated exemplary embodiment of cleaning apparatus 20 is shown in greater detail in the exploded views of FIGS. 4 and 5. It will be apparent to those skilled in the art that the various components of cleaning apparatus 20 could be secured together in any suitable manner by means of any suitable components. For example, in some embodiments, some or all of the components of cleaning apparatus 20 are held in place using glue or other suitable adhesives, are coupled together using ultrasonic welding or other suitable process, are engaged in a snap-fit engagement or a friction-fit engagement, are engaged in a threaded engagement, or are integrally formed. Additionally, any number of intermediate connecting components for coupling central housing 22 to any suction attachment 24 or vacuum source that may be used can be added or subtracted, depending on considerations of ease of use, desired application, manufacturability, and the like.

In the illustrated embodiment, an upstream coupler 40 is provided that engages in a snap-fit or friction-fit engagement with both the downstream end of suction attachment 24 and the upstream end of central housing 22. Any suitable means of engagement could be used, for example, a threaded engagement, coupling with suitable adhesives or permanent ultrasonic welding, or the like, or upstream coupler 40 could be integrally formed with either or both of central housing 22 and suction attachment 24.

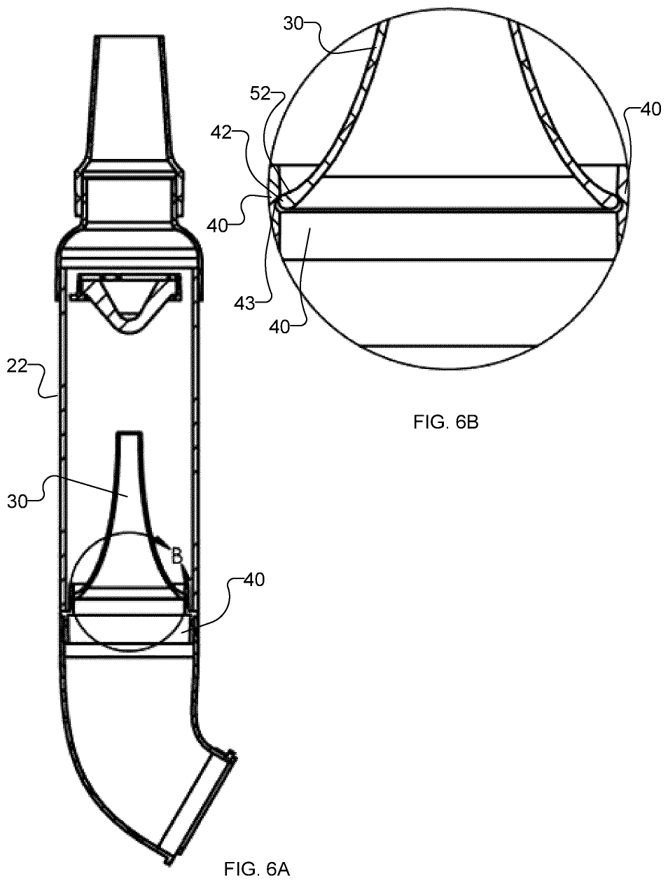

With reference to FIGS. 6A and 6B, in the illustrated embodiment, the base 52 of airflow cone 30 is provided with a retaining flange 42 provided at the upstream widest portion of airflow cone 30. In the illustrated embodiment, central housing 22 is provided with a circumferential interior recess 43 on its inner surface. Retaining flange 42 of airflow cone 30 engages in a snap fit into interior recess 43.

In the illustrated embodiment, filter 32 is provided with a retainer 44 that engages with a cap piece 46 to secure filter 32 in place. Cap piece 46 in turn engages in a friction fit with vacuum attachment end 26, although any suitable means of connection could be used. In some embodiments, a support member 47 (FIG. 3A) is provided downstream of filter 32 to help support filter 32 and/or to prevent filter 32 from being sucked downstream by an applied vacuum force. In some such embodiments, filter 32 has a generally planar configuration (i.e. is generally flat rather than being generally conically shaped). In some embodiments, support member 47 is omitted. In some embodiments in which filter 32 is provided with a generally conical configuration, support member 47 is omitted. In some embodiments, the material from which filter 32 is formed holds its shape sufficiently well (whether generally flat, generally conical, or some other shape) so that an additional support is not required to maintain the shape of filter 32 and/or to prevent filter 32 from being sucked downstream by vacuum forces.

As best seen in FIG. 4, in the illustrated embodiment, filter 32 has a generally conical configuration, with the apex 48 of the cone provided at the upstream end thereof, and the base 50 provided at the downstream end thereof. As described in more detail below, this generally conical configuration of filter 32 may assist in ensuring that filter 32 does not become clogged with debris when cleaning apparatus 20 is in use.

In some embodiments, filter 32 is provided as a generally planar (i.e. generally flat) filter. In such embodiments, the flow of fluid within interior space 38 directs debris entrained within the fluid to collect at a debris collection zone in an upstream region of interior space 38, which avoids clogging of the generally planar filter, since debris tends not to contact the upstream surface of the filter 32. In some embodiments, the distance 33 between airflow cone 30 and filter 32 is sufficiently large (i.e. airflow cone 30 and filter 32 are spaced apart by a sufficient distance) so that debris entering interior space 38 tends not to contact filter 32.

As also clearly seen in FIG. 4, airflow cone 30 has a generally conical shape, with the base 52 at the upstream end thereof and a truncated vertex 54 at the downstream end thereof. The truncated vertex 54 of airflow cone 30 has an aperture 56 (FIG. 5) therethrough and the interior of airflow cone 30 is hollow, to provide a fluid path to allow fluid to flow through airflow cone 30 and into the interior space 38 of central housing 22 when cleaning apparatus 20 is in use. Airflow cone 30 thus directs the flow of fluid entering interior space 38.

In some embodiments, the aperture 56 of airflow cone 30 is provided with a one-way valve. The one-way valve allows fluid to flow into the interior space 38 of central housing 22 when a vacuum pressure is applied to cleaning apparatus 20 in use, but does not allow fluid, including air or debris, including crawling or flying pests, to exit back out through aperture 56 when cleaning apparatus 20 is not in use. Any suitable type of one-way valve can be used, for example, a ball check valve, a diaphragm check valve, or a tilting disc check valve.

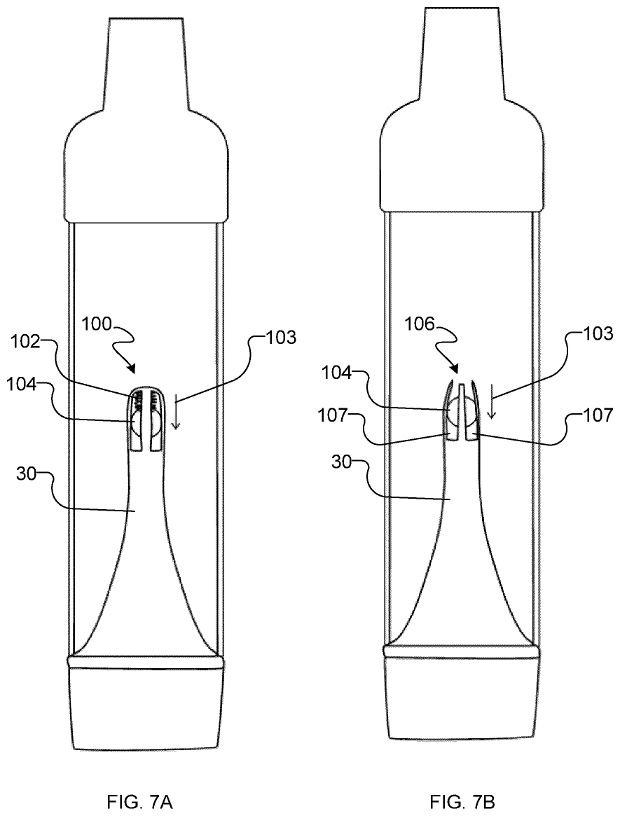

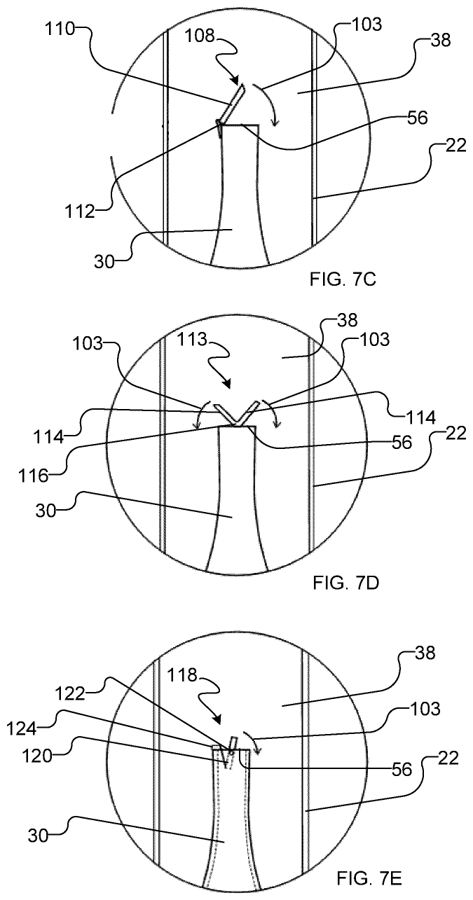

With reference to FIGS. 7A, 7B, 7C, 7D and 7E, five different example embodiments of suitable one-way valves are illustrated. The pressure required to open the one-way valve selected for use on airflow cone 30 should be selected to be commensurate with the anticipated vacuum force that will be applied by the vacuum source, to ensure that the one-way valve will open under the downstream fluid pressure created on it by the activation of the vacuum source to which cleaning apparatus 20 is connected, which results in a decrease in pressure within interior space 38.

FIG. 7A shows an example embodiment having a spring-loaded ball valve 100 using a helical coil spring 102 to force a ball 104 ordinarily upstream against a valve seat to form a seal (in the direction shown by arrow 103). Upon activation of fluid flow by application of vacuum source, ball 104 is forced away from the valve seat by the fluid pressure applied upstream of ball 104, to permit fluid to flow through airflow cone 30.

FIG. 7B shows an example embodiment of a one-way valve 106 having a ball 104 that is ordinarily forced upstream against a valve seat (in the direction shown by arrow 103). One-way valve 106 operates on a similar principle to ball valve 100, except that a plurality of tines 107 are provided to support ball 104. The plurality of tines 107 are angled inwardly in the downstream direction, and are made from a flexible material that can flex outwardly to allow ball 104 to travel in the downstream direction under the downstream fluid force created when the vacuum source is activated to allow fluid to pass through aperture 56. When the vacuum source is turned off or disconnected, the plurality of tines 107 flex inwardly back to their starting position, pushing ball 104 in the upstream direction against the valve seat. The plurality of tines 107 also prevent ball 104 from being sucked out of position (e.g. inwardly into the interior space 38 of housing 22) under applied vacuum pressure.

FIG. 7C shows an example embodiment of a one-way valve 108 made from a flap 110 made of elastic material. In its relaxed state, flap 110 sits over aperture 56 and lies against the peripheral edges of aperture 56 (as indicated by the direction of arrow 103), preventing the upstream flow of fluid, including debris, including pests, through aperture 56. Under the downstream fluid force created when the vacuum source is activated, flap 110 is lifted off aperture 56, to permit fluid flow therethrough.

In the illustrated embodiment of FIG. 7C, flap 110 is affixed at one edge 112 of aperture 56, and the remaining portions of flap 110 are free to move in the downstream direction under the downstream fluid force created when the vacuum source is activated. FIG. 7D shows an embodiment of a one-way valve 113 that is similar to that of FIG. 7C, except that a flap 114 of elastic material is affixed at two points 116 to the edge of aperture 56, so that a centreline of flap 114 remains fixed in place, while the two halves of flap 114 are free to move in the downstream direction under the downstream fluid force created by activation of the vacuum source to allow fluid to flow through aperture 56, but are ordinarily sealed against the edges of aperture 56 in the direction indicated by arrows 103. It will be obvious to those skilled in the art that flap 114 need not be affixed to aperture 56 exactly along its centreline, and that other points of attachment, including asymmetrical points of attachment, could be used in alternative embodiments.

FIG. 7E shows an example embodiment of a one-way valve 118 in which a swiveling disc 120 is provided to prevent the upstream movement of pests or their eggs when the vacuum source connected to cleaning apparatus 20 is not activated. The swiveling disc 120 is attached to a hinge 122 and is ordinarily sealed against a seat 124, but opens to allow fluid to flow in the downstream direction under the downstream fluid force created by activation of the vacuum source to which cleaning apparatus 20 is connected.

To use cleaning apparatus 20, a user couples a vacuum source (e.g. a conventional household or commercial grade vacuum cleaner) to vacuum attachment end 26 with a sealing engagement. Activation of the vacuum source creates a negative pressure at the downstream end of cleaning apparatus 20, so that air, as well as any dust, debris, pests, cast skins, eggs, or other material that can be sucked up by the vacuum is sucked through the upstream end of suction attachment 24, through the interior of airflow cone 30, and into the interior space 38 of central housing 22.

As shown in FIG. 8A, the presence of airflow cone 30 creates a dead air space or debris collection zone 60 that is positioned upstream of aperture 56 of airflow cone 30. Without being bound by theory, arrows 58 illustrate what is believed to be the path of fluid flow taken initially by air and debris entering the interior space 38 of central housing 22 after passing through airflow cone 30. Debris tends to enter central housing 22 and accumulate in the upstream region of central housing 22, in the dead air space or debris collection zone 60 that is positioned upstream of aperture 56 of airflow cone 30. The fact that incoming debris accumulates in debris collection zone 60 rather than travelling downstream within central housing 22 to impact filter 32 helps to prevent filter 32 from becoming clogged with debris.

Without being bound by theory, the inventors believe that one reason that dead air space 60 is formed within the interior space 38 of cleaning apparatus 20 upstream of aperture 56 is due to a Venturi effect produced as fluid flows through the relatively narrower diameter of airflow cone 30 into interior space 38. Fluid passing through the constriction presented by airflow cone 30 has a higher velocity but lower pressure than air that has already exited the airflow cone 30 into the interior space 38 of housing 22, which has lower velocity but higher pressure.

The inventors have constructed and tested an exemplary cleaning apparatus 20, and have confirmed that debris entering interior space 38 of such exemplary apparatus does tend to accumulate in the upstream portion of interior space 38 upstream of aperture 56 of airflow cone 30, in dead zone or debris collection area 60. This is illustrated in the photographs shown in FIGS. 8B and 8C, which show photographs demonstrating the operation of an exemplary prototype built and tested by the inventors.

As shown in FIG. 8B, when suction attachment 24 is oriented upwardly at an angle of 150° relative to a vertical orientation in which suction attachment 24 is oriented directly downwardly and an applied suction force is provided from a vacuum source, debris tends to accumulate in the collection area 60 of housing 22, as circled on FIG. 8B. In contrast, as shown in FIG. 8C in which suction attachment 24 is oriented downwardly, at an angle of 220° relative to a vertical orientation in which suction attachment 24 is oriented directly downwardly, and no suction force is applied, the debris falls to the upstream end of housing 22. The position of the debris in FIG. 8C is indicated by arrow 61.

In some embodiments, filter 32 is shaped and configured so that any debris that reaches filter 32 tends to move along the surface of filter 32 and accumulate adjacent base 50 of filter 32, rather than clogging the surface of filter 32. In one such example embodiment, as in the illustrated embodiment, filter 32 is provided with a generally conical shape. The apex 48 of filter 32 is oriented in the upstream direction. Without being bound by theory, debris that contacts the upstream surface of filter 32 tends to continue to be pulled along the surface of filter 32 towards its base 50 due to the suction force applied by the vacuum source.

As will be apparent to those skilled in the art, the shape of filter 32 and airflow cone 30 need not be perfectly conical, i.e. have perfectly straight edges tapering from the base to the vertex of such cone. In particular, airflow can be directed appropriately along the surfaces of these components even if their edges are not perfectly straight. Thus, as used herein, the term “generally conical” means that the shape of filter 32 and airflow cone 30 tapers generally along a line from a wide base to a narrow vertex. However, the line from the base to the vertex need not be perfectly straight, and in some embodiments could follow a gently convex or concave curvature or have slightly asymmetrical profiles, so long as airflow can be directed appropriately by these components to perform their intended function.

The presence of airflow cone 30 and the generally conical shape of filter 32, with its apex 48 oriented in the upstream direction, are, both singly and in combination, structural features that can help to prevent filter 32 from becoming clogged with debris.

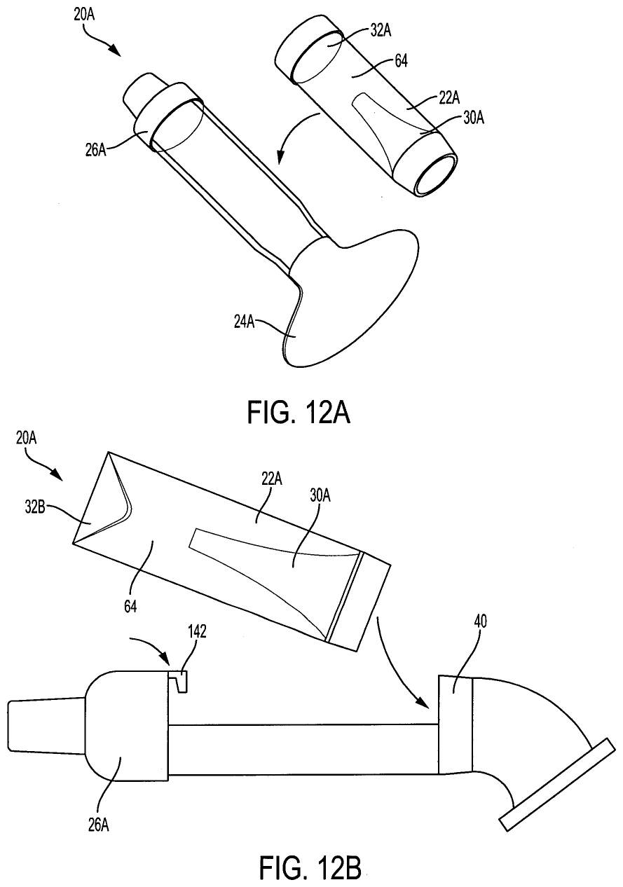

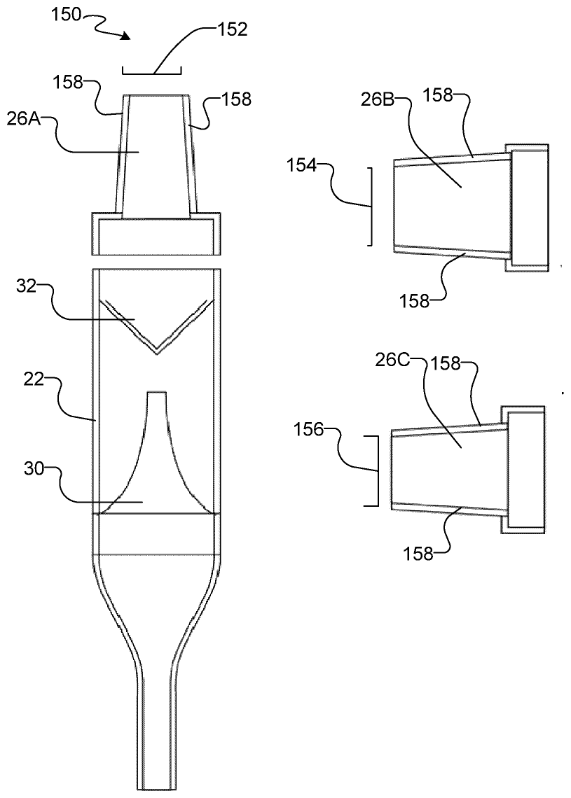

In embodiments in which central housing 22 is made from a transparent or semi-transparent material, a user may visually inspect cleaning apparatus 20 during use to evaluate the amount of debris collected by the device and/or to assess whether filter 32 may be starting to become clogged. If filter 32 becomes covered or clogged with debris, the ability of the vacuum source to provide a suction pressure through cleaning apparatus 20 will be reduced, therefore reducing the efficiency of the cleaning process. Thus, if a user observes that filter 32 is becoming clogged, the user should stop using cleaning apparatus 20 and take appropriate remedial action, for example dismantling cleaning apparatus 20 to remove debris and clean filter 32, changing an exchangeable cartridge containing a replaceable central portion containing a clean filter 32 in embodiments in which cleaning apparatus 20 includes an exchangeable cartridge (an example embodiment of which is shown in FIGS. 12A and 12B), and/or disposing of cleaning apparatus 20 and commencing use of a new cleaning apparatus 20 in embodiments in which cleaning apparatus 20 is disposable.

In some embodiments, as shown in FIG. 8A, central housing 22 is provided with one or a plurality of spaced apart measuring lines 62, so that a user can visually determine the extent to which debris has collected in debris collection area 60. In some embodiments, the measuring lines 62 are provided to indicate a maximum fill line, indicating the farthest extent of debris accumulation that a user should permit before emptying or changing cleaning apparatus 20 or an exchangeable cartridge thereof. In some embodiments, a user switches off the vacuum source and allows accumulated debris to fall to the upstream end of housing 22 (e.g. as shown in FIG. 8C) in order to consistently assess the level of accumulated debris relative to any provided measuring lines 62.

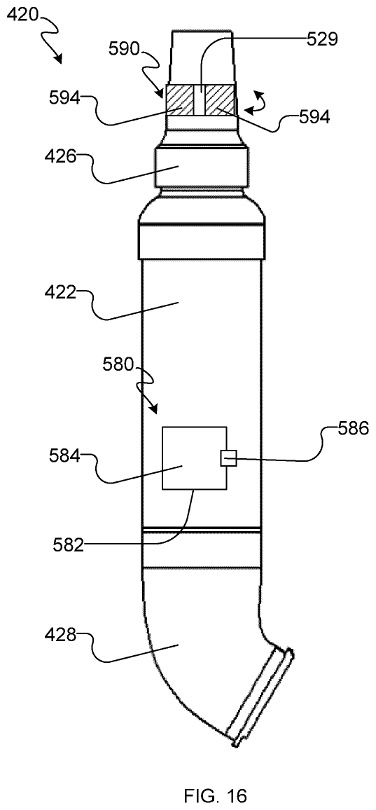

In some embodiments, after use of cleaning apparatus 20, a user applies a suitable pesticide to the apparatus to kill any pests and/or pest eggs that have been vacuumed into central housing 22. In some embodiments, central housing 22 includes a window that is ordinarily sealed during use, but that can be opened to allow a user to insert a pesticidal product into the interior space 38 of central housing 22. In some embodiments, such a window could be the window 580 described with reference to FIG. 16 or a window similar thereto. In some embodiments, a user inserts a pad that has been pre-dosed with a pesticidal substance into interior space 38, for example as described in Patent Cooperation Treaty patent application No. PCT/IB2014/066139, which is incorporated by reference herein in its entirety for all purposes.

In some embodiments, a cover (shown as 136 in FIG. 10A) is provided to cover the contact base 34 of suction attachment 24. In some embodiments, the portion of the cover 136 that comes into contact with contact base 34 comprises an absorbent material. A user can dose the absorbent material with a pesticidal substance, so that any pests or their eggs that may become adhered to contact base 34 will be killed when the cover is put into place on suction attachment 24.

In some embodiments, after a user has finished using cleaning apparatus 20, the outside surface of cleaning apparatus 20 is sterilized in any suitable manner, to kill any pests or their eggs that may have become adhered to the outside surface of cleaning apparatus 20. In some embodiments, a user applies a pesticidal spray to the outside surface of cleaning apparatus 20 after use. In some embodiments, a user wipes the outside surface of cleaning apparatus 20 after use using a wipe that has been moistened with a pesticidal composition. In some embodiments, a user places cleaning apparatus 20 inside a treatment enclosure and inserts a device for releasing pesticidal vapors within the treatment enclosure as described in PCT/IB2014/066139, for example an absorbent pad impregnated with a pesticidal composition, and seals the treatment enclosure for a suitable period to kill any pests or their eggs on or in cleaning apparatus 20.

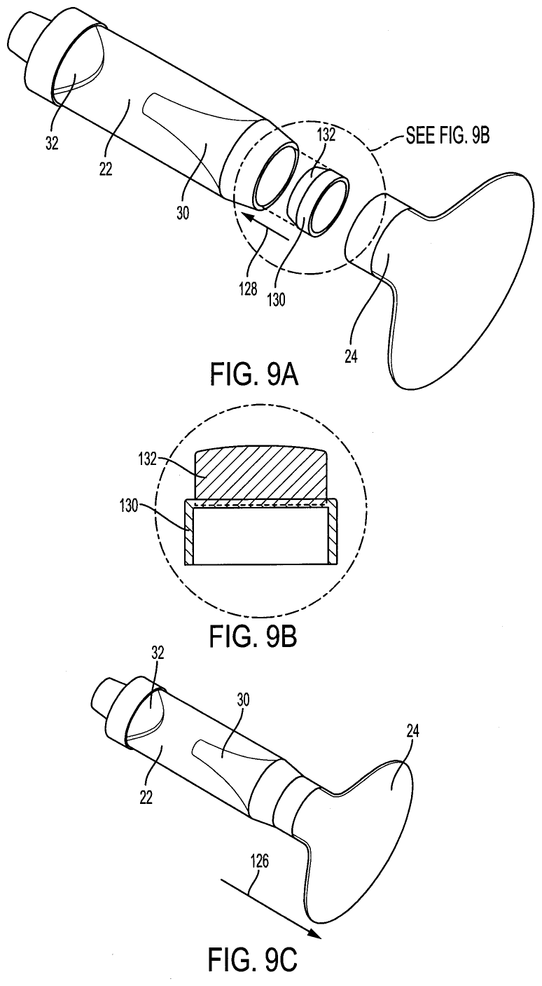

In some embodiments, as illustrated with reference to FIGS. 9A, 9B and 9C, a lid 130 is provided to cover the base of housing 22 after use of cleaning apparatus 20. In the illustrated embodiment, after use, a user removes suction attachment 24 by pulling in the direction indicated by arrow 126 in FIG. 9C in embodiments using a friction fit. To facilitate removal, suction attachment 24 may be joined to housing 22 in any suitable removable manner, for example, using a friction fit, a snap fit, threaded engagement, or the like. Lid 130 is engageable with housing 22 in a like manner, so that lid 130 can be detachably coupled to housing 22 in place of suction attachment 24. For example, in the illustrated embodiment, lid 130 can be engaged in a friction fit with housing 22 by inserting lid 130 in the direction indicated by arrow 128 in FIG. 9A. Attachment of lid 130 can prevent any pests from escaping (e.g. crawling or flying) out of housing 22 via airflow cone 30 when cleaning apparatus 20 is not in use.

As illustrated in FIG. 9B, in some embodiments, including the illustrated embodiment, the downstream portion of lid 130 is provided with an absorbent pad 132 that can be dosed with a pesticidal composition. In this way, when lid 130 is coupled to housing 22, the pesticidal vapors released from absorbent pad 132 will kill any pests or their eggs that are trapped inside housing 22. In some such embodiments, a corresponding lid is provided that is sealingly engageable with the downstream end of housing 22 or vacuum attachment end 26, to ensure that pesticidal vapors released from absorbent pad 132 remain trapped within interior space 38 of housing 22 to kill pests and or their eggs inside housing 22. In some embodiments, absorbent pad 132 is omitted. In some embodiments, a base 134 is provided that can be connected to lid 130, to facilitate convenient storage of cleaning apparatus 20 when not in use.

In some embodiments in which absorbent pad 132 is provided on lid 130, airflow cone 30 is not provided with a one-way valve at its downstream end, since the pesticidal vapors would be impeded from entering interior space 38 by the one-way valve.

In some embodiments, a window or coverable opening is provided in housing 22 for inserting an absorbent pad impregnated with a pesticidal composition inside housing 22. Openable aperture 580 described with reference to FIG. 16 is an example of such a window or coverable opening. In some such embodiments, a lid for covering either or both the upstream and downstream ends of housing 22 is provided.

In some embodiments, instead of or in addition to providing absorbent pad 132 on lid 130 for attachment to the upstream end of housing 22, as shown in FIGS. 10A and 10B, an absorbent pad 135 is provided on a lid 134 that is sealingly engageable with the downstream end of housing 22 or vacuum attachment end 26. Since pesticidal vapors released from a pesticidal composition impregnated into absorbent pad 135 can pass through filter 32, the pesticidal vapors can enter interior space 38 to kill pests and their eggs that are trapped therein, even in embodiments in which airflow cone 30 is provided with a one-way valve.

In an alternative embodiment illustrated in FIG. 11, a bag 138 is provided to cover the upstream end of housing 22 and/or suction attachment 24 after use of cleaning apparatus 20. In some embodiments, including the illustrated embodiment, an elastic tie 140 or other closure mechanism is provided to secure bag 138 in a sealed manner against housing 22 and/or suction attachment 24, to ensure that pests are not able to escape from housing 22 into the surrounding environment while bag 138 is in place. In some embodiments, a user may insert a device for releasing pesticidal vapors, for example an absorbent pad dosed with a pesticidal composition, into bag 138 prior to sealing bag 138 in place, to kill any pests or their eggs in bag 138 and optionally in housing 22.

In some embodiments, a cleaning apparatus is provided with an exchangeable cartridge. The exchangeable cartridge allows removal of at least accumulated debris and the filter, so that use of the cleaning apparatus can continue without clogging the filter.

With reference to FIGS. 12A and 12B, in one example embodiment of such a cleaning apparatus 20A, the exchangeable cartridge 64 includes housing 22A, filter 32A, and airflow cone 30A. The filter 32A has a planar (i.e. generally flat) configuration in the illustrated embodiment of FIG. 12A. The downstream end of exchangeable cartridge 64 is suitable to be sealingly engaged with vacuum attachment end 26A, and the upstream end of exchangeable cartridge 64 is suitable to be sealingly engage with upstream coupler 40 and/or outlet 36 of suction attachment 24A, so that exchangeable cartridge 64 can be readily inserted into or removed from cleaning apparatus 20A. It will be obvious to those skilled in the art that the exact components that form part of exchangeable cartridge 64 can be varied to optimize various considerations such as user convenience, ease of use, minimization of waste materials, etc.

In the illustrated embodiment of FIG. 12B, exchangeable cartridge 64 is provided with a filter 32B having a generally conical shape, and is configured at its upstream end to be engageable in a sealed snap-fit engagement with upstream coupler 40 and at its downstream end to be engageable in a sealed snap-fit engagement with vacuum attachment end 26A. A user is thus able to readily snap exchangeable cartridge 64 out of cleaning apparatus 20A when desired, and insert a new exchangeable cartridge 64 in its place. A locking element 142 is provided on vacuum attachment end 26A, to facilitate locking exchangeable cartridge 64 in place for use. Locking element 142 could be provided in any desired location (e.g. alternatively on upstream coupler 40 and/or outlet 36 of suction attachment 24A). Locking element 142 is omitted in some embodiments.

In some embodiments, exchangeable cartridge 64 is made from biodegradable materials, to facilitate disposal of exchangeable cartridge 64 in an environmentally sound manner.

In some embodiments, cleaning apparatus 20 is designed to be disposable. In one example embodiment of a disposable cleaning apparatus 20, the shape and configuration of the components of cleaning apparatus 20 are optimized to use as little material as possible. In another example embodiment of a disposable cleaning apparatus 20, the shape and configuration of the components of cleaning apparatus 20 are optimized to allow manufacture of the disposable cleaning apparatus 20 at a minimal cost. In another example embodiment of a disposable cleaning apparatus 20, the components of cleaning apparatus 20 are made from a biodegradable material, to facilitate disposal of cleaning apparatus 20 in an environmentally sound manner.

In one example embodiment, the components of cleaning apparatus 20 are designed to be microwaveable (i.e. are made of materials that are of a type and configuration so as to not melt, suffer damage, or cause arcing in a microwave), so that cleaning apparatus 20 can be microwaved after use for a sufficient time to kill or inactivate any pests or their eggs that are sucked into or adhered onto cleaning apparatus 20. In some embodiments, exchangeable cartridge 64 is designed to be microwaveable, so that exchangeable cartridge 64 can be microwaved after use for a sufficient time to kill or inactivate any pests or their eggs that are sucked into exchangeable cartridge 64.

With reference to FIG. 13, an example embodiment of a kit 150 for connecting cleaning apparatus 20 to a variety of different vacuum sources having hoses of a plurality of different diameters is schematically illustrated. First adapter 26A for connecting cleaning apparatus 20 to a first vacuum source has a downstream end having a relatively narrow diameter 152. Second adapter 26B for connecting apparatus 20 to a second vacuum source having a hose of a relatively larger diameter has a downstream end with a diameter 154 that is larger than diameter 152. Third adapter 26C for connecting apparatus 20 to a third vacuum source having a hose of an intermediate diameter between those of the first and second vacuum sources has a downstream end of an intermediate diameter 156 that is between diameter 152 and diameter 154. In some embodiments, any desired number of different adapters 26 having differing diameters at their downstream ends can be provided for coupling cleaning apparatus 20 to a plurality of different vacuum sources having hoses of different diameters, e.g. 1, 2, 3, 4, 5, 6, 7, 8, 9, or 10 different adapters 26.

As can be seen in the illustrated embodiment, adapters 26A, 26B and 26C all have a tapered surface 158 which tapers radially inwardly in the downstream direction. In different embodiments, the length and degree of taper of tapered surface 158 can be varied. In some embodiments, a plurality of different vacuum sources having different connection diameters can be coupled to the same adapter 26 by virtue of the length and degree of taper of tapered surface 158.

With reference to FIGS. 14A, 14B and 14C, alternative embodiments of a nesting adapter are illustrated. With reference to FIG. 14A, an example embodiment of a kit having a plurality of detachably connectable nesting adapters 160 for connecting cleaning apparatus 20 to a variety of different vacuum sources having connection hoses of a plurality of different diameters is illustrated. The upstream end of first nesting adapter 162 engages the downstream end of housing 22. First nesting adapter 162 for connecting cleaning apparatus 20 to a first vacuum source has a downstream end having a relatively narrow diameter 162A. The upstream end of second nesting adapter 164 engages the downstream end of first nesting adapter 162. Second nesting adapter 164 for connecting apparatus 20 to a second vacuum source having a connection hose of a relatively larger diameter has a downstream end with a diameter 164A that is larger than diameter 162A. Similarly, the upstream end of third nesting adapter 166 engages the downstream end of second nesting adapter 164. Third nesting adapter 166 has a downstream end with a diameter 166A that is larger than diameter 164A. Lastly, the upstream end of forth nesting adapter 168 engages the downstream end of third nesting adapter 166. Fourth nesting adapter 168 has a downstream end with a diameter 168A that is larger than diameter 166A.

In use, a user can couple any desired number of nesting adapters 162, 164, 166 and 168 to cleaning apparatus 20, to render the diameter of the downstream end of cleaning apparatus 20 suitable for engagement to the particular connection hose the user desires to use to couple cleaning apparatus 20 to a vacuum source.

FIG. 14B shows an embodiment of a plurality of nesting adapters 170 similar to that of FIG. 14A, except that the diameters of the downstream end of any two adjacent nesting adapters decrease in the downstream direction. FIG. 14C shows an example embodiment of a kit having a plurality of different nesting adapters similar to that shown in FIG. 14A, except that only the first two nesting adapters 162 and 164 are illustrated, and have slightly different diameters than those that are illustrated in FIG. 14A.

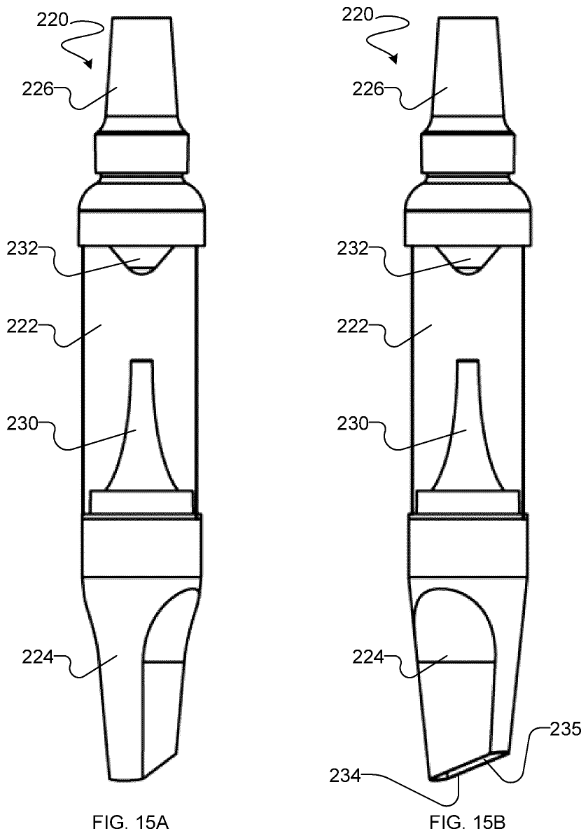

With reference to FIGS. 15A and 15B, an alternative embodiment of a cleaning apparatus 220 for connection to a suction attachment 224 that is a crevice tool is illustrated. Elements of cleaning apparatus 220 that serve the same function as like elements of cleaning apparatus 20 are referred to using reference numerals incremented by 200, and specific details thereof are not described again but are incorporated for apparatus 220 based on the earlier description of apparatus 20 provided above.

Cleaning apparatus 220 is generally similar to cleaning apparatus 20, except that suction attachment 224 comprises a crevice tool having a relatively narrow intake opening 235, as compared with the relatively wide intake opening 35 illustrated for cleaning apparatus 20 (FIG. 3C), in which suction attachment 24 comprises an upholstery attachment. Cleaning apparatus 220 is particularly well suited to removal of pests that may congregate and/or lay their eggs in cracks or crevices, including for example bed bugs, since the crevice tool provided as suction attachment 224 may be able to generate larger suction forces to remove debris from tight spaces such as cracks and crevices than, for example, a floor tool or upholstery attachment.

In embodiments in which cleaning apparatus 220 is intended to be used to remove bed bugs, filter 232 need not be a HEPA filter. Filter 232 need only be able to prevent or impede particles having a size of approximately 100 microns or greater from passing through filter 232. A filter 232 that can prevent particles having a size of approximately 100 microns or greater from passing through will prevent passage of bed bug eggs, nymphal stages and adult bed bugs out of cleaning apparatus 220, and unlike in the case of dust mites, smaller particles of debris associated with bed bugs (e.g. feces and cast skins) are less likely to be allergenic.

In some embodiments, cleaning apparatus 20 is particularly well suited to removal of pests that may congregate and/or lay their eggs on surfaces, for example of upholstery, furniture, and the like, or in bedding or other linens, for example, dust mites. In such cases, having a relatively wider intake opening 35, for example as provided on an upholstery tool, as compared with intake 235 may facilitate increased speed in vacuuming the area from which the pests are to be removed. In embodiments in which cleaning apparatus 20 is to be used to remove dust mites, filter 32 is provided as a filter that is capable of removing particles having a size of approximately 1 micron or larger, and in some embodiments is provided as a HEPA filter.

As used herein, a suction attachment is considered to meet the definition of a “crevice tool” if the surface area of the intake opening 235 is equal to or less than the surface area of a radial cross-section of the connection hose of the vacuum source with which the suction attachment is used. In some example embodiments, a “crevice tool” has an intake opening 235 that is ½″ or less wide (including e.g. ⅜″, ¼″ or ⅓″ wide), and 2″ or less long (including e.g. ½″, 1″ or 1½″). In some embodiments, the intake opening 235 of a crevice tool is oriented in parallel to the suction inlet to which the crevice tool is connected.

As used herein, a suction attachment is considered to meet the definition of an “upholstery attachment” if the surface area of the intake opening 35 is at least approximately three times the surface area of a radial cross-section of the connection hose of the vacuum source with which the suction attachment is used, up to approximately fifteen times the surface area of a radial cross-section of the connection hose of the vacuum source with which the suction attachment is used, or up to approximately four, five, six, seven, eight, nine, ten, eleven, twelve, thirteen or fourteen times the surface area of a radial cross-section of the connection hose of the vacuum source with which the suction attachment is used. In some embodiments, an “upholstery attachment” has an intake opening 35 having a width of between ½″ to 1½″ (including any value therebetween, e.g. ¾″, 1″, or 1¼″) and a length of between 3″ and 8″, including any value therebetween, e.g. 3½, 4, 4½, 5, 5½, 6, 6½, 7, or 7½″. In some embodiments, the intake opening 35 is oriented in a direction perpendicular to the suction inlet to which the upholstery attachment is attached.

In some embodiments, cleaning apparatus 20 or 220 is used to remove other types of pests from other locations. For example, in some embodiments, cleaning apparatus 20 or 220 is used to suck up and remove common household pests such as cockroaches, silverfish, termites, wood lice, spiders, flies (including fruit flies, house flies, bottle flies), mosquitos, moths (including pantry moths), bees, wasps, ants, fleas, lice, undesired insects and the like, by visually locating and vacuuming such pests into cleaning apparatus 20 or 220. In some embodiments, the pests may be removed directly from the skin or hair of an infested person or animal using cleaning apparatus 20 or 220.

In some embodiments, cleaning apparatus 20 or 220 is used to remove unwanted pests from plants in agricultural, horticultural, household or domestic lawn or garden settings, or the like. A user upon visually determining that a plant or area has become infested with an unwanted pest such as fruit flies, aphids, thrips, whiteflies, scales, psyllids, stink bugs, mites, beetles, caterpillars or the like can use cleaning apparatus 20 or 220 to suck up and remove such pests.

In some embodiments, it may be desired to capture and release an organism that could be considered to be a pest, but which it is desired to transfer in a living state from one location to another. For example, many people consider spiders to be a desirable organism because they consume other insects, but people may also not want spiders to live inside their household. A user could capture a spider using cleaning apparatus 20 or 220, and then transfer the spider to a different location and release it from cleaning apparatus 20 or 220 in a live state. As another example, it may be desirable to vacuum up a queen bee from a first location using cleaning apparatus 20 or 220 and transfer the queen bee in a live state to a second, different, location. Accordingly, in some embodiments, cleaning apparatus 20 or 220 is provided with structural features that facilitate the capture and release of organisms in a live state.

Three structural features that can facilitate the capture and release of organisms in a live state include an openable window or aperture that can be provided on central housing 22 or 222 to allow an organism to escape from central housing 22 or 222 when a user desires to release the organism; an easily releasable engagement of any of the components of cleaning apparatus 20 or 220, e.g. a threaded engagement or a snap-fit engagement, to allow a user to easily remove one or more of the components and access interior space 38 or 238 of central housing 22 or 222 to release the organism; and, a vacuum bleed that can be used to reduce the suction force applied by a vacuum source, to help minimize the risk that capture of an organism by suction and passage through airflow cone 30 or 230 into interior space 38 or 238 will kill the organism.

With reference to FIG. 16, an example embodiment of a cleaning apparatus 420 that is provided with an openable window 580 to allow organisms to be released from central housing 422 and a vacuum bleed 590 that can be used to reduce suction force applied by a vacuum source is illustrated schematically, using reference numerals incremented by 400 to describe like parts of the cleaning apparatus.

Cleaning apparatus 420 has a closeable window 580 that has an opening 582 formed in the side of housing 422, with a hinged window covering 584 that sits over and covers opening 582. Hinged window covering 584 is engageable with housing 422 in any suitable manner to allow a user to open and close hinged window covering 584 as desired to open or cover opening 582. In the illustrated embodiment, a latch 586 is provided on the edge of hinged window covering 584 opposite its hinges, so that a user can snap hinged window covering 584 between its open and closed configurations. In some embodiments, instead of a hinged window covering, opening 582 is covered by a rotatable sheath with an aperture defined therein as described below for vacuum bleed 590, so that opening 582 can be opened by rotating the rotatable sheath to the correct position to align an opening in the rotatable sheath with opening 582.

Vacuum bleed 590 comprises an opening 529 in any suitable location on cleaning apparatus 420, which is on vacuum attachment end 426 in the illustrated embodiment. A rotatable generally circular sheath 594 is provided over opening 529, and includes therein an aperture that can be rotated about the circumference of vacuum attachment end 426. When the aperture of generally circular sheath 594 is aligned over opening 529, vacuum is permitted to bypass the remaining portions of cleaning apparatus 420, so that the suction forces therein, particularly within airflow cone 430, will be lower than would otherwise be the case, i.e. a portion of the vacuum forces are bled off. When a user desires to apply the full force of the vacuum source through cleaning apparatus 420, the user can rotate generally circular sheath 594 to decrease the amount of this aperture that is aligned over opening 529, which will result in a corresponding increase in the suction force applied through airflow cone 430. In this way, a user can start with an initially reduced vacuum force, and then gradually increase the vacuum force to be only that required to suck up the living organism into the interior space 438 of central housing 422. A user can then transfer cleaning apparatus 420 to the desired release location for the living organism, and release the living organism through opening 582.

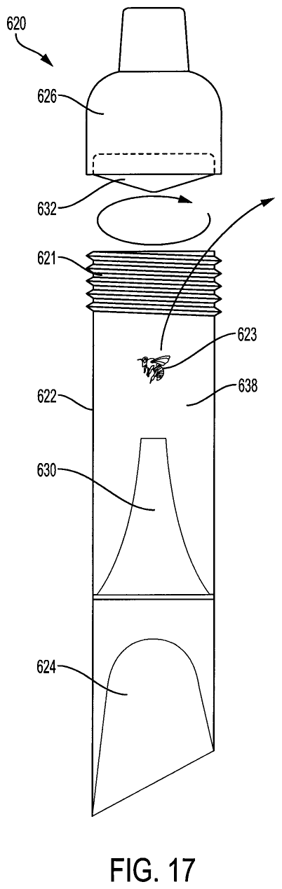

With reference to FIG. 17, an alternative example embodiment of a cleaning apparatus 620, which is generally similar to cleaning apparatus 220 and for which like parts are referred to with like reference numerals incremented by 400, is illustrated. The downstream end of housing 622 is provided with a threaded surface 621, which is threadably engageable with a correspondingly threaded surface provided on the inner surface of vacuum attachment end 626, which also contains filter 632. In use, after an organism has been captured using apparatus 620, e.g. a flying insect such as the illustrated bee 623, cleaning apparatus 620 can be transported to a desired release location, and will contain bee 623 because bee 623 is unable to fly out of interior chamber 638 via airflow cone 630. Upon reaching the desired release location, a user can twist vacuum attachment end 626 relative to housing 622 to disengage threaded surface 621 from vacuum attachment end 626, thereby releasing bee 623 at the desired release location.

In some embodiments, a cleaning apparatus such as 20 or 220, (or 420 or 620) can be used for any other applications in which it is desired to prevent debris from entering the bag or canister of a vacuum. For example, in one such embodiment, the debris that it is desired to collect in interior space 38 or 238 of cleaning apparatus 20 or 220 is drywall dust. In some such embodiments, filter 32 or 232 is a HEPA filter, to prevent fine particles of drywall dust from being vacuumed into the bag or canister of a vacuum source. In one example embodiment, a method of vacuuming up drywall dust while preventing the drywall dust from entering the bag or canister of the vacuum source is provided. The method includes affixing a cleaning apparatus 20 or 220 to the connection hose of a vacuum source, activating the vacuum source to generate a suction pressure to draw fluid into the interior space 38 or 238 of the cleaning apparatus 20 or 220 via an airflow cone 30 or 230, to thereby collect the drywall dust in a debris collection area 60 or 260 of the apparatus 20 or 220. In such embodiments, the filter 32 or 232 acts as a further structural mechanism to prevent the drywall dust from being vacuumed into the bag or canister of the vacuum source.

In another embodiment, the debris that it is desired to collect in interior space 28 or 228 of cleaning apparatus 20 or 220 is pet hair and/or pet dander. In some such embodiments, filter 32 or 232 is a HEPA filter, to prevent allergens from being vacuumed into the bag or canister of a vacuum source. In one example embodiment, a method of vacuuming up pet hair and/or pet dander while preventing the pet hair and/or pet dander from entering the bag or canister of the vacuum source is provided. The method includes affixing a cleaning apparatus 20 or 220 to the connection hose of a vacuum source, activating the vacuum source to generate a suction pressure to draw fluid into the interior surface 38 or 238 of the cleaning apparatus 20 or 220 via an airflow cone 30 or 230, to thereby collect the pet hair and/or pet dander in a debris collection area 60 or 260 of the apparatus 20 or 220. In such embodiments, the filter 32 or 232 acts as a further structural mechanism to prevent the pet hair and/or pet dander from being vacuumed into the bag or canister of the vacuum source.

Suitable materials for use in the manufacture of cleaning apparatus 20 or 220 can be ascertained by those skilled in the art, and the different components of cleaning apparatus 20/220 can independently be made from different suitable materials. In some embodiments, central housing 22/222, suction attachment 24/224 and airflow cone 30/230 are made from a plastic material, for example acrylonitrile butadiene styrene (ABS), polyethylene terephthalate (PET), polyvinyl chloride (PVC), polypropylene, high density polyethylene (HDPE), low density polyethylene (LDPE), polymethyl methacrylate, cellulose acetate butyrate, polycarbonate, glycol modified polyethylene terephthalate, styrene acrylonitrile, nylon, polylactic acid, polyhydroxyalkanoate, polytetrafluoroethylene, polystyrene, and the like.

In some embodiments, central housing 22/222, suction attachment 24/224 and airflow cone 30/230 are made from a biodegradable material, for example, cardboard, nitrocellulose, starch, cellulose pulp, polyhydroxyalkanoate, polylactic acid, polybutylene succinate, polycaprolactone, polyethylene terephthalate, cellulose acetate, nitrocellulose, polyvinyl alcohol, polylactic acid, and the like.

In embodiments in which central housing 22/220 is transparent, central housing 22/220 is made from any suitable transparent material, for example nitrocellulose, polypropylene, high-density polyethylene, low-density polyethylene, polyvinyl chloride, acrylonitrile butadiene styrene, polymethyl methacrylate, cellulose acetate butyrate, polycarbonate, glycol modified polyethylene terephthalate, styrene acrylonitrile, nylon, polylactic acid, polyhydroxyalkanoate, polytetrafluoroethylene, polystyrene, or the like, or glass in some embodiments, although glass presents a potential consumer hazard because it can be easily broken.

In some embodiments, cleaning apparatus 20/220, excluding filter 32/232, is integrally formed, e.g. is manufactured as a single piece of material. In some embodiments, different subsets of the components of cleaning apparatus 20/220 are integrally formed, e.g. are manufactured as a single piece of material.

Filter 32/232 can be made from any suitable material, and can be provided with any configuration that allows filter 32/232 to perform the desired function of filtering out debris, including pests and their eggs, while still allowing the vacuum source to draw a sufficient amount of air through cleaning apparatus 20/220 to achieve the desired effect of vacuuming up debris. In some embodiments, the filter comprises a fibrous polyester, for example, low density polyethylene (LDPE), polypropylene, high density polyethylene (HDPE), polyethylene terephthalate (PET), or the like.

In some embodiments, the filter comprises compressed fibres with oriented strands. In some embodiments, the filter comprises a HEPA filter. In some embodiments, the filter is capable of isolating particles that are 50 microns (approximately the size of bed bug eggs) to several centimetres (the size of many adult insects), including any value therebetween, e.g. 100, 200, 300, 400, 500, 600, 700, 800, or 900 microns, or 1, 2, 3, 4, 5, 6, 7, 8, 9 or 10 centimetres. In some embodiments used to remove dust mites from a given location, the filter is capable of isolating particle that vary in size from 1 micron up to 0.5 mm, including any value therebetween, e.g. 10, 25, 50, or 75 microns or 0.1, 0.2, 0.3, or 0.4 mm.

Suitable dimensions for the various components of cleaning apparatus 20/220 can be selected by those skilled in the art based on the particular planned use of cleaning apparatus 20/220.

As a general guideline, airflow cone 30/230 should be provided with a sufficient length in a direction along its central axis to ensure that pests are not able to crawl up airflow cone 30/230 and escape in embodiments in which another mechanism for preventing the escape of pests from central housing 22/222 is not provided (examples of such mechanisms would include providing airflow cone 30/230 with some mechanism, for example a one-way valve, to prevent pests from escaping through aperture 56; or a removable cover for covering suction attachment 24/224 or inlet 28/228 when cleaning apparatus 20/220 is not in use).

Airflow cone 30/230 should also be provided with a sufficient length in a direction along its central axis to avoid having debris fill debris collection area 60/260 too quickly.

Airflow cone 30/230 should be spaced apart from filter 32/232 by a sufficient distance 33 to ensure that air is directed towards dead zone 60/260, rather than directly onto filter 32/232.

The diameter of airflow cone 30/230 should be selected to ensure that airflow within the interior space 38/238 of central housing 22/222 is directed towards dead zone 60/260, rather than directly onto filter 32/232. If the diameter of airflow cone 30/230 is too narrow, the velocity of air entering interior space 38/238 will be too high, and debris will tend to be directed onto filter 32/232 rather than into debris collection zone 60/260. If the diameter of airflow cone 30/230 is too wide, the velocity of air entering interior space 38/238 will be too low. In embodiments in which it is desired to use cleaning apparatus 20/220 to move live organisms from one location to another, the diameter of airflow cone 30/230 should be sufficiently large to ensure the organism can pass through airflow cone 30/230 with a low probability of mortality.

In some embodiments, the dimensions of cleaning apparatus 22/222, including airflow cone 30/230, are optimized for the use of a particular type of suction attachment 24/224; for example the airflow entering cleaning apparatus 20/224 will be different if suction attachment 224 is a crevice tool than if suction attachment 24 is a floor tool or an upholstery tool.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

### REFERENCES

The following references are of interest with respect to the subject matter described herein. Each of the following references is incorporated by reference herein in its entirety for all purposes.
Calderón M A, Linnenberg A, Kleine-Tebbe J, De Blay F, Hernandez Fernandez de Rojas D (2015) Respiratory allergy caused by house dust mites: What do we really know? Journal of Allergy and Clinical Immunology 136: 38-48.
Custovic A, Woodccock H, Craven M., Hassall R, Hadley E, Simpson A, woodcock A (1999) Dust mite allergens are carried on noto only large particles. Pediatric Allergy Immunol. 10: 258-260.

1. A cleaning apparatus for attachment to a vacuum source, the cleaning apparatus comprising:
a housing defining an interior space and being engageable with the vacuum source to draw fluid through the interior space in a downstream direction, the fluid comprising both air and debris;
a filter provided in a downstream portion of the housing and engaged with the housing so that the air exiting the interior space must pass through the filter; and
an inlet tube engaged with the housing and spaced apart from the filter in the upstream direction.

2. A cleaning apparatus as defined in claim 1, wherein the inlet tube provides a fluid flow pathway to direct fluid entering the interior space.

3. A cleaning apparatus as defined in claim 1, wherein, in use, fluid flowing through the inlet tube is initially directed in the upstream direction towards a debris collection zone of the interior space to deposit the debris in the debris collection zone, the debris collection zone being positioned upstream of an inlet aperture provided at a downstream end of the inlet tube; and optionally wherein the configuration of the inlet tube produces a Venturi effect on fluid flowing through the inlet tube.

4. A cleaning apparatus as defined in claim 1, wherein the inlet tube and the filter are spaced apart by a sufficient distance so that the debris entering the interior space through the inlet tube generally does not impact on the filter.

5. A cleaning apparatus as defined in claim 1, wherein the filter comprises a generally conical shape having an apex and a base, with the apex of the filter being oriented in the upstream direction within the housing.

6. A cleaning apparatus as defined in claim 1, wherein the filter comprises a generally planar shape.

7. A cleaning apparatus as defined in claim 1, wherein the inlet tube comprises a generally conical configuration, and wherein the inlet tube has a truncated vertex that is oriented in a downstream direction.

8. A cleaning apparatus as defined in claim 1, wherein the inlet tube is tapered in a downstream direction so that the fluid flow pathway narrows in diameter in the downstream direction.

9. A cleaning apparatus as defined in claim 1, wherein:
an outer surface of the inlet tube comprises a sticky pest control surface that prevents or inhibits pests moving along the outer surface of the inlet tube;
an outer surface of the inlet tube comprises a slippery pest control surface that prevents or significantly inhibits pests moving along the outer surface of the inlet tube; and/or
the inlet tube comprises a slippery pest control material.

10. (canceled)

11. (canceled)

12. A cleaning apparatus as defined in claim 1, wherein a or the inlet aperture provided at a downstream end of the inlet tube is operatively engaged with a one-way valve to allow fluid to flow only into the housing, wherein the one-way valve optionally comprises a spring-loaded ball check valve, a diaphragm check valve, or a tilting disc check valve.

13. (canceled)

14. A cleaning apparatus as defined in claim 1, wherein the housing comprises a sealable window and/or wherein the housing comprises a transparent material.

15. (canceled)

16. A cleaning apparatus as defined in claim 1, further comprising a suction attachment engageable with the upstream end of the housing, the suction attachment having a contact base for contacting a surface to be vacuumed.

17. A cleaning apparatus for attachment to a vacuum source, the cleaning apparatus comprising:
a housing defining an interior space and being engageable with the vacuum source at a downstream end of the housing to draw fluid through the interior space, the fluid comprising air and debris;
a filter provided in a downstream portion of the housing and engaged with the housing so that the air exiting the interior space must pass through the filter;
an inlet tube engaged with the housing and spaced apart from the filter in the upstream direction; and
a suction attachment engageable with the upstream end of the housing, the suction attachment having a contact base for contacting a surface to be vacuumed;
the housing and the suction attachment being sealingly engageable to be placed in fluid communication with one another.

18. A cleaning apparatus as defined claim 17, wherein:
the inlet tube provides a fluid flow pathway to direct fluid entering the interior space; and/or
the apparatus comprises a vacuum adapter for coupling a downstream portion of the housing with a vacuum source.

19. (canceled)

20. A cleaning apparatus as defined in claim 1, further comprising a cover that is sealingly engageable with at least one of:
the upstream end of the housing or a component that is in sealing engagement with the housing; or
the downstream end of the housing or a component that is in sealing engagement with the housing, including the vacuum attachment end.

21. A cleaning apparatus as defined in claim 20, wherein the cover further comprises an absorbent substrate for receiving a liquid pesticidal composition and releasing vapors of the pesticidal composition into the interior space of the housing.

22. A cleaning apparatus as defined in claim 17, comprising a cover configured to be placed in sealing engagement with the contact base, wherein the cover optionally comprises an absorbent material for receiving a liquid pesticidal composition positioned to be placed in contact with the contact base when the cover is engaged over the contact base.

23. A kit comprising a cleaning apparatus as defined claim 1 in combination with at least two adapters for attaching the downstream end of the housing to a connection hose of the vacuum source, each one of the at least two adapters being configured to couple the vacuum attachment end to a connection hose having a different diameter.

24. A cleaning apparatus as defined in claim 1, wherein:
the filter substantially impedes the passage of particles having a size of 0.3 microns or larger, 1 micron or larger, 50 microns or larger, 100 microns or larger, 250 microns or larger, or 500 microns or larger;
the suction attachment comprises an upholstery attachment, a rug brush, a floor attachment, a crevice tool, a dusting brush, a pet brush, or a dusting wand;
the suction attachment comprises an upholstery attachment, and wherein the filter substantially impedes the passage of particles having a size of one micron or larger;
the suction attachment comprises a crevice tool, and wherein the filter substantially impedes the passage of particles having a size of approximately 100 microns or larger;
the apparatus comprises a vacuum bleed for reducing the amount of suction through the inlet tube; and/or
at least two components of the apparatus are in threaded engagement with one another, to facilitate the release of organisms trapped in the interior space.

25. (canceled)

26. (canceled)

27. (canceled)

28. (canceled)

29. (canceled)

30. A method of operating a cleaning apparatus engageable with a vacuum source, the method comprising the steps of:
providing a negative pressure at a downstream end of a housing of the cleaning apparatus using the vacuum source;
using the pressure differential created by the vacuum source, drawing fluid through a fluid pathway defined by an inlet tube provided at an upstream end of the housing into an interior space of the housing, wherein optionally that the fluid pathway causes the fluid to experience a Venturi effect; and
drawing air exiting the housing through a filter positioned downstream of the inlet tube.

31.-44. (canceled)
